(19) United States
(12) Patent Application Publication
(10) Pub. No.: US 2018/0276187 A1
(43) Pub. Date: Sep. 27, 2018

(54) OPERATION-SCREEN GENERATION DEVICE AND NON-TRANSITORY COMPUTER READABLE MEDIUM

(71) Applicant: FUJI XEROX CO., LTD., Tokyo (JP)

(72) Inventors: Naoko SATO, Kanagawa (JP); Masatoshi TAGAWA, Kanagawa (JP); Toshihide FUJII, Kanagawa (JP)

(73) Assignee: FUJI XEROX CO., LTD., Tokyo (JP)

(21) Appl. No.: 15/680,798

(22) Filed: Aug. 18, 2017

(30) Foreign Application Priority Data
Mar. 24, 2017 (JP) 2017-059670

(51) Int. Cl. G06F 17/22; G06F 17/24; G06F 17/21

(52) U.S. Cl. CPC G06F 17/2241; G06F 3/0481; G06F 17/212; G06F 17/248

(57) ABSTRACT

An operation-screen generation device includes a reading unit that reads operation item information indicating multiple operation items having a hierarchical structure and used to generate an operation screen and a generation unit that generates the operation screen. An operation component for an operation item in a highest layer in the operation item information is allocated to a first hierarchical component predetermined as being in a highest layer in layout information. If the number of subsequent layers for one or more subsequent operation items is equal to or smaller than a predetermined number of layers displayable for a second hierarchical component, one or more operation components for the one or more subsequent operation items are allocated to the second hierarchical component. If the number of subsequent layers is larger than the predetermined number of layers, the operation components are allocated to the second hierarchical component and a third hierarchical component.

### CROSS-REFERENCE TO RELATED APPLICATIONS

This application is based on and claims priority under 35 USC 119 from Japanese Patent Application No. 2017-059670 filed Mar. 24, 2017.

### BACKGROUND

### (i) Technical Field

The present invention relates to an operation-screen generation device and a non-transitory computer readable medium.

### (ii) Related Art

When a complex operation screen involves settings for a large number of items, setting parameters are hierarchized and categorized into groups in accordance with the significance of the setting parameters and are displayed by using tabs and the like. In this case, a large number of layers might lead to a large number of operation steps for designating the layer.

### SUMMARY

According to an aspect of the invention, there is provided an operation-screen generation device including a reading unit and a generation unit. The reading unit reads operation item information indicating multiple operation items having a hierarchical structure. The operation items is used to generate an operation screen. The generation unit generates the operation screen such that an operation component for one of the operation items that is located in a highest layer in the hierarchical structure in the operation item information read by the reading unit is allocated to a first hierarchical component for hierarchically displaying the operation items by using a predetermined number of layers. The first hierarchical component is predetermined as being located in a highest layer in layout information indicating layout of the first hierarchical component and a second hierarchical component for displaying the operation items by using a predetermined number of layers and for operating the operation items. The generation unit generates the operation screen such that if the number of subsequent layers for one or more subsequent operation items in the hierarchical structure is equal to or smaller than the predetermined number of layers displayable for the second hierarchical component, one or more operation components for the one or more subsequent operation items are allocated to the second hierarchical component. The generation unit generates the operation screen such that if the number of subsequent layers is larger than the predetermined number of layers displayable for the second hierarchical component, the operation components for the subsequent operation items are allocated to the second hierarchical component and a third hierarchical component.

### BRIEF DESCRIPTION OF THE DRAWINGS

An exemplary embodiment of the present invention will be described in detail based on the following figures, wherein:

FIG. 1 is a block diagram schematically illustrating the configuration of an operation-screen generation device according to the exemplary embodiment;

FIG. 2 is a diagram illustrating an example design template described in a markup language;

FIG. 3 is a diagram illustrating an example design of an operation screen;

FIG. 4 is a table illustrating an example of definition of assigned components;

FIGS. 5A and 5B are diagrams illustrating an example of an operation-item definition file;

FIG. 6 is a diagram illustrating an example hierarchical structure of operation items that is represented by the operation-item definition file;

FIG. 7 is a flowchart illustrating an example process performed by the operation-screen generation device according to the exemplary embodiment;

FIG. 8 is a flowchart specifically illustrating an example of a hierarchical-component/assigned-component determination process performed by a hierarchical-component/assigned-component determination unit;

FIG. 9 is a diagram illustrating an example operation screen generated by the operation-screen generation device according to the exemplary embodiment;

FIG. 10 is a diagram illustrating an example in which hierarchical components are made independently settable by adding a layer;

FIG. 11 is a diagram illustrating an example in which the operation-item definition file is provided with information indicating that operation items are intended to be collectively set; and

FIG. 12 is a flowchart illustrating an example hierarchical-component/assigned-component determination process executed in a case where operation items are to be collectively set.

### DETAILED DESCRIPTION

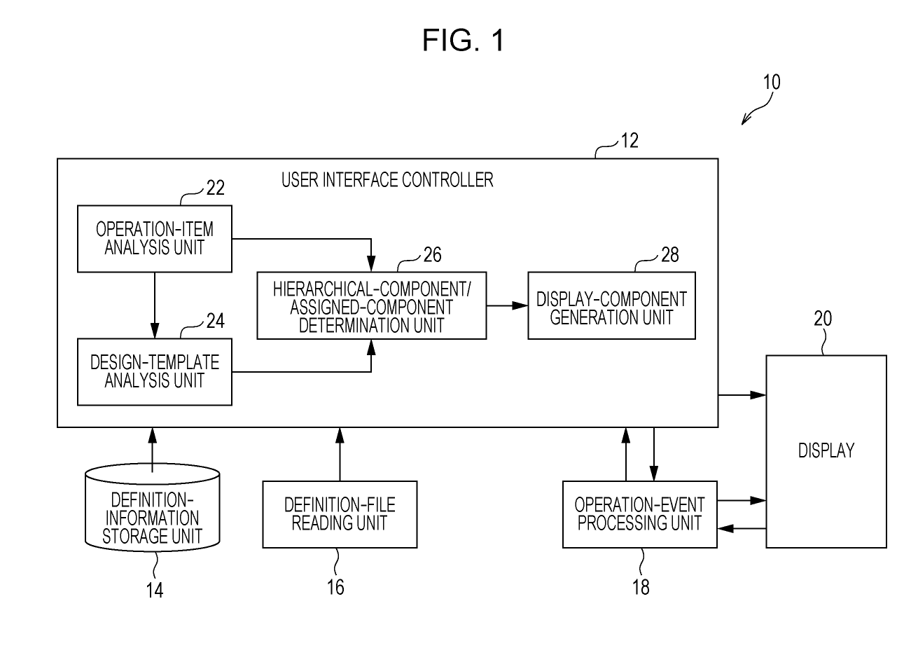

Hereinafter, an example of an exemplary embodiment of the present invention will be described in detail with reference to the drawings. FIG. 1 is a block diagram schematically illustrating the configuration of an operation-screen generation device 10 according to the exemplary embodiment.

The operation-screen generation device 10 according to the exemplary embodiment generates an operation screen for operating an electronic device such as an image output device having at least one of functions of a printer, a fax machine, and a copier and an apparatus including a computer. The operation-screen generation device 10 according to the exemplary embodiment may be included in an electronic device, or a computer for operating an electronic device may be used as the operation-screen generation device 10.

The operation-screen generation device 10 according to the exemplary embodiment generates an operation screen for plainly displaying setting parameters hierarchized and categorized into groups in accordance with the significance of the setting parameters. The setting parameters are displayed by using hierarchical components such as tabs and the like for hierarchically displaying operation items.

The operation-screen generation device 10 according to the exemplary embodiment includes a user interface controller 12, a definition-information storage unit 14, a definition-file reading unit 16, an operation-event processing unit 18, and a display 20. The user interface controller 12 and the definition-information storage unit 14 serve as an example of a generation unit, and the definition-file reading unit 16, the operation-event processing unit 18, and the display 20 serve as an example of a reading unit.

On the basis of information stored in the definition-information storage unit 14 and information read by the definition-file reading unit 16, the user interface controller 12 generates an operation screen on which a hierarchical display is displayed. This will be described in detail later.

The definition-information storage unit 14 stores therein design templates of operation screens and information regarding assigned components to be allocated to hierarchical components. The design templates serve as an example of layout information. One of various memory devices such as a hard disk may be used as the definition-information storage unit 14, or an external server or another device may be used.

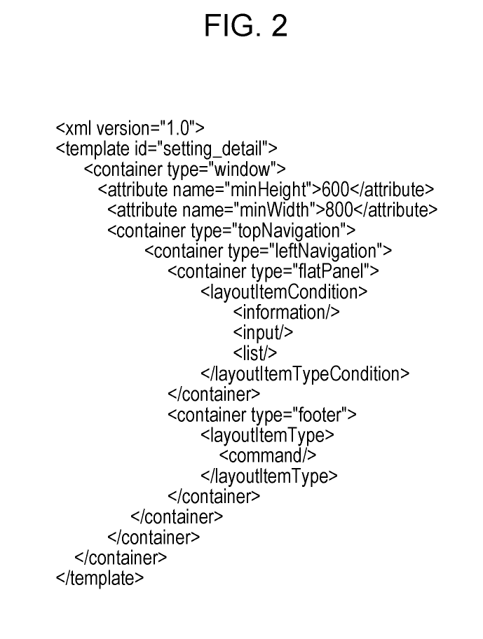

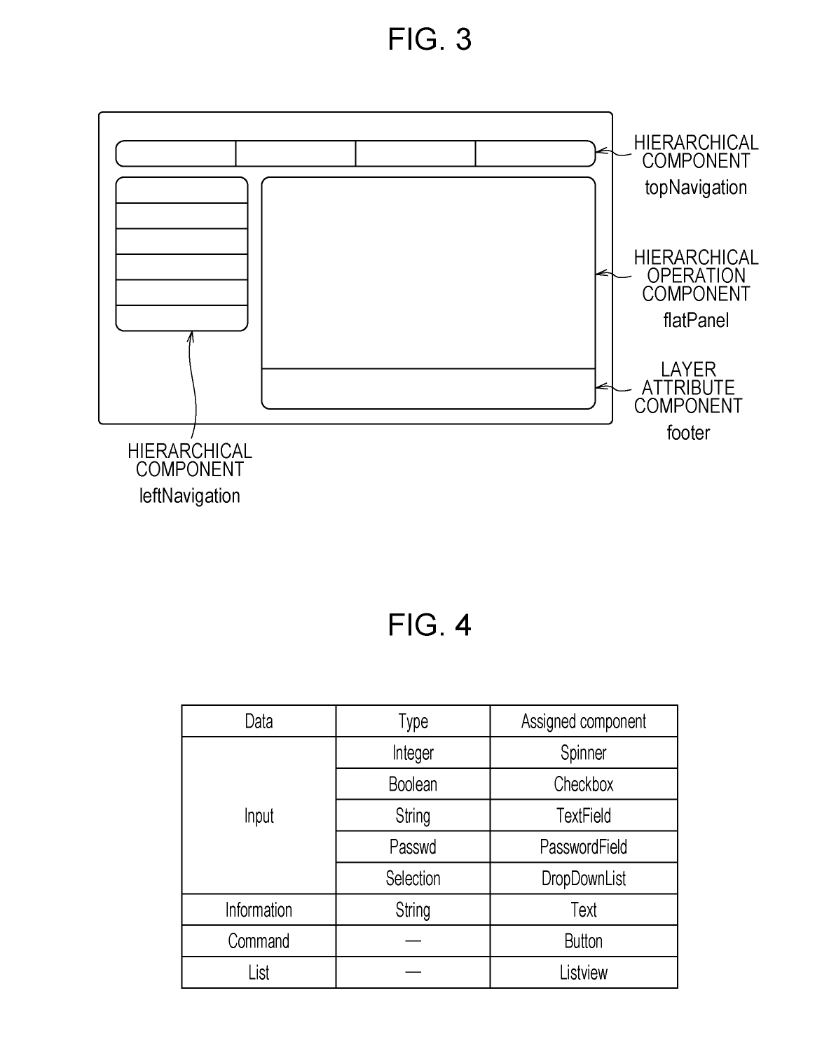

Each design template is layout information indicating the layout of multiple hierarchical components. Multiple types of design templates in different layouts are stored in the definition-information storage unit 14. Specifically, each design template is provided in a markup language such as Extensible Markup Language (XML), as illustrated in FIG. 2, and the design template in FIG. 2 represents the design of an operation screen as illustrated in FIG. 3. The example in FIG. 3 includes a hierarchical component topNavigation, a hierarchical component leftNavigation, a hierarchical operation component flatPanel, and a layer attribute component footer. In the example in FIG. 3, the hierarchical component topNavigation, the hierarchical component leftNavigation, and the hierarchical operation component flatPanel are hierarchically displayed in this order. In addition, the number of hierarchically displayable layers is predetermined for each hierarchical component. Note that the hierarchical components include a first hierarchical component for hierarchically displaying operation items and a second hierarchical component for displaying and operating the operation items. In the exemplary embodiment, the hierarchical component topNavigation and the hierarchical component leftNavigation each correspond to the first hierarchical component, and the hierarchical operation component flatPanel corresponds to the second hierarchical component.

The assigned components are operation components for the operation items. Specifically, the assigned components are defined for each data category of the operation items. For example, as illustrated in FIG. 4, assigned components (Spinner, Checkbox, TextField, PasswordField, DropDownList, Text, Button, and ListView) of types (Integer, Boolean, String, Passwd, and Selection) are defined for each data category (Input, Information, Command, and List). Note that the assigned components are not limited to those of the types illustrated in FIG. 4, and other publicly known components are usable as the assigned components.

The definition-file reading unit 16 reads an operation-item definition file as operation item information indicating multiple operation items to be arranged on the operation screen. The definition-file reading unit 16 may read the operation-item definition file from various media such as a magnetic disk, an optical disk, and a semiconductor memory or from an external personal computer, a server, and another apparatus through a communication network or another network.

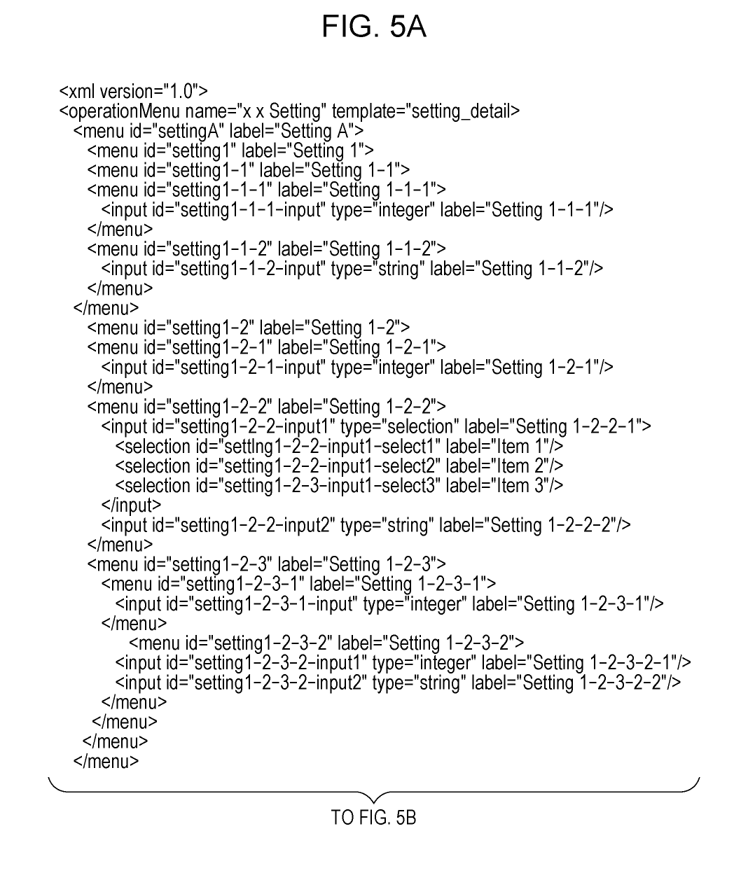

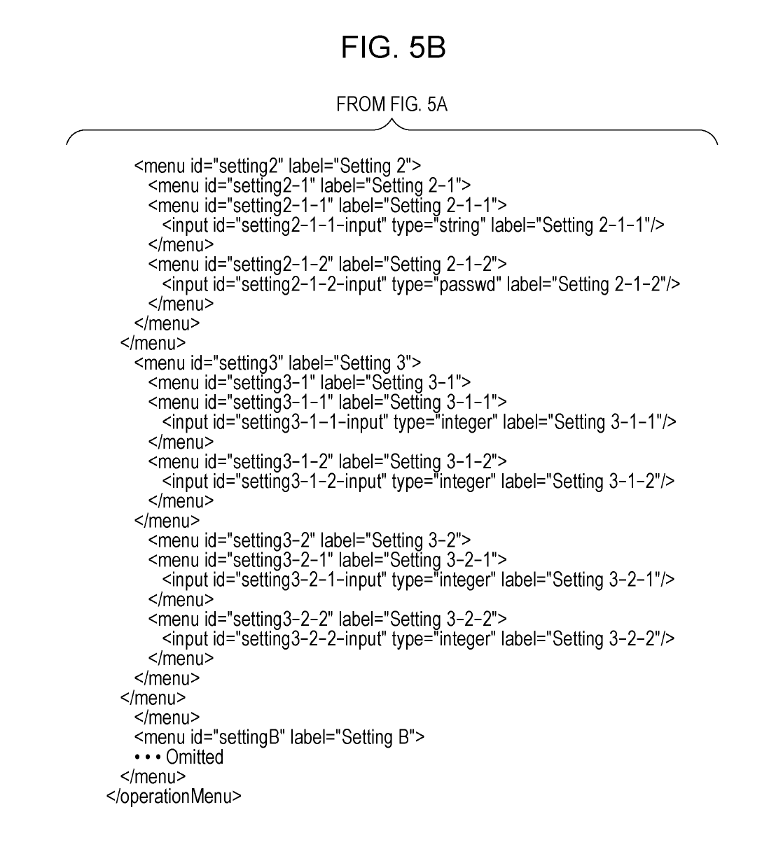

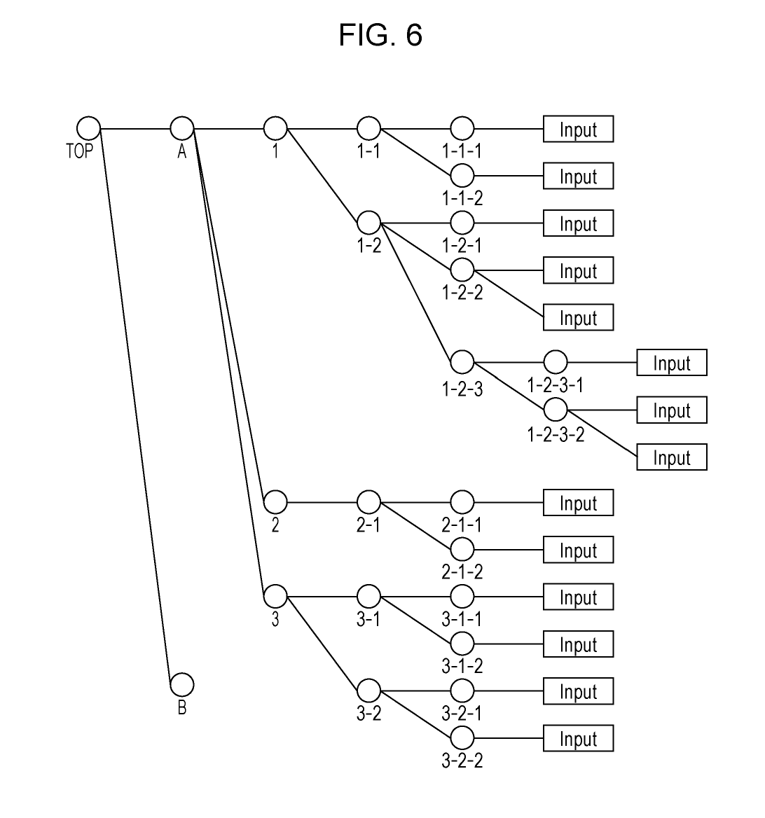

The operation-item definition file is provided in a markup language such as XML, as is the design template. The operation-item definition file has information regarding the multiple operation items used for the operation screen. For example, as illustrated in FIGS. 5A and 5B, the definitions of the operation items are described. The operation-item definition file provided in XML and illustrated in FIGS. 5A and 5B represents the hierarchical structure of the operation items illustrated in FIG. 6. In other words, the example in FIG. 6 illustrates a hierarchical structure in which, for example, “Setting A” has lower layers of “Setting 1”, “Setting 2”, and “Setting 3” and each setting has a hierarchical structure having a lower layer. FIG. 6 also illustrates “Input” as a part for input in the lowest layer.

The operation-event processing unit 18 notifies the user interface controller 12 of information regarding an operation performed by a user with an operation unit such as a keyboard, a mouse, or an operation button. The operation-event processing unit 18 also executes a process provided for the operation on the operation screen and a process for displaying, on the display 20, the process provided for the operation.

A display such as a liquid crystal display is used as the display 20, and the display 20 displays an operation screen generated by the user interface controller 12.

The configuration of the user interface controller 12 for generating an operation screen will be described in detail.

The user interface controller 12 includes an operation-item analysis unit 22, a design-template analysis unit 24, a hierarchical-component/assigned-component determination unit 26, and a display-component generation unit 28. The user interface controller 12 is configured of a computer including, for example, a central processing unit (CPU), a read-only memory (ROM), a random-access memory (RAM), and other components. A program stored in the ROM or the like is loaded in the RAM and run by the CPU, and the units described above thereby function. Such a configuration is applied to the user interface controller 12. Note that a configuration in which the units described above function by only hardware including a semiconductor integrated circuit and the like may be applied to the user interface controller 12.

The operation-item analysis unit 22 analyzes the operation-item definition file read by the definition-file reading unit 16 and notifies the design-template analysis unit 24 of described template identification information.

The design-template analysis unit 24 reads, from the definition-information storage unit 14, a design template corresponding to the identification information notified by the operation-item analysis unit 22, analyzes the content of the read design template, and generates, for example, the operation screen schematically illustrated in FIG. 3. In the example in FIG. 3, the number of layers displayable is predetermined for each hierarchical component as described above. For example, the number of layers displayable for each type of the hierarchical components may be stored as a map in the definition-information storage unit 14. In the example in FIG. 3, the number of layers for the hierarchical component topNavigation is predetermined as 1, the number of layers for the hierarchical component leftNavigation is predetermined as 3, and the number of layers for the hierarchical operation component flatPanel is predetermined as 2. The reason why the number of layers for the hierarchical component topNavigation is 1 is that if a component at this location is provided with a lower layer, screen design might be compromised at the time of development, and operability might be impaired. Regarding the hierarchical component left Navigation, developing lower layers to some extent at this location does not severely impair operability, and thus a larger number of layers than that for the hierarchical component topNavigation is determined. The hierarchical operation component flatPanel corresponds to a portion where, for example, the user actually performs an operation, a setting operation, and the like. This example assumes a scenario for a screen on which the user repeats, to some extent, selection of an operation component allocated to a hierarchical component until a target operation component allocated to a hierarchical component is displayed (in other words, one or more transitions from a higher-level menu to a lower-level menu occurs) and lastly opens an operation screen. The example above is merely an example, and another scenario is naturally conceivable. It is conceived that, to determine the layout of the operation components on the operation screen for the hierarchical component (left navigation), minimizing the number of hierarchical components displayed until the hierarchical operation component is displayed leads to an improvement in user operability. If a screen to be generated is actually displayed, the screen convenience may be determined. Accordingly, it is conceivable that a convenient use case is a case in which the screen design and the configuration are changed many times and a screen to be generated may be determined easily.

On the basis of the definition of the assigned components stored in the definition-information storage unit 14 and the results of analyses performed by the operation-item analysis unit 22 and the design-template analysis unit 24, respectively, the hierarchical-component/assigned-component determination unit 26 executes a hierarchical-component/assigned-component determination process for determining assigned components to be assigned to the hierarchical components.

In the hierarchical-component/assigned-component determination process, an operation item in the highest layer described in the operation-item definition file is first allocated to a hierarchical component predetermined as being in the highest layer represented in the design template.

It is then determined whether the number of subsequent layers for a subsequent operation item in the operation-item definition file is larger than the number of layers hierarchically displayable for the hierarchical operation component. If the result of the determination is negative, the subsequent operation item followed by the subsequent layers is displayable in the hierarchical operation component. In this case, the operation item followed by the subsequent layers is allocated to the hierarchical operation component, and an assigned component to be allocated to the hierarchical operation component is determined on the basis of the operation-item definition file.

In contrast, if the result of the determination is affirmative and the operation item followed by the subsequent layers is not displayable in the hierarchical operation component, it is determined whether it is possible to add a layer to the corresponding hierarchical component. If a layer is addable, the layer is added, and the operation item is allocated to the added layer. An assigned component is then determined on the basis of the operation-item definition file. If a layer is not addable, a component for opening a different screen is allocated.

It is serially determined whether the number of subsequent layers for each operation item in the operation-item definition file is larger than the number of layers displayable for the hierarchical operation component, the operation item is allocated to the corresponding hierarchical component, and an assigned component is determined for the hierarchical component on the operation screen.

The display-component generation unit 28 reads, from the definition-information storage unit 14, the definition of the assigned component determined by the hierarchical-component/assigned-component determination unit 26, allocates the assigned component to the hierarchical component, and generates display data regarding the operation screen to be displayed on the display 20. The display-component generation unit 28 then displays the operation screen represented by the generated display data on the display 20 on the basis of the display data.

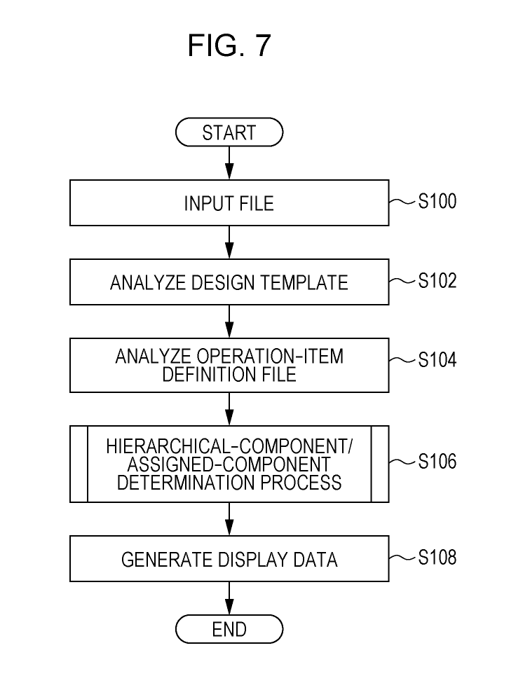

A process performed by the operation-screen generation device 10 in the above-described configuration according to the exemplary embodiment will be described specifically with reference to FIG. 7. FIG. 7 is a flowchart illustrating an example of the process performed by the operation-screen generation device 10 according to the exemplary embodiment.

In step S100, the definition-file reading unit 16 reads the operation-item definition file and thereby inputs the operation-item definition file in the user interface controller 12. The process then proceeds to step S102.

In step S102, the design-template analysis unit 24 analyzes a design template. The process then proceeds to step S104. The design-template analysis unit 24 reads, from the definition-information storage unit 14, a design template corresponding to design template identification information described in the operation-item definition file and generates hierarchical components in accordance with the read design template. For example, the design-template analysis unit 24 reads, from the definition-information storage unit 14, a design template (for example, the design template illustrated in FIG. 2) corresponding to identification information (setting detail) regarding a template (template) described in the operation-item definition file illustrated in FIGS. 5A and 5B. The design-template analysis unit 24 generates the hierarchical components in accordance with the content (the shape, the size, the location, and the like of each hierarchical component) of the design template and generates the operation screen as schematically illustrated in FIG. 3 as an example.

In step S104, the operation-item analysis unit 22 analyzes the read operation-item definition file. The process then proceeds to step S106. In other words, the operation-item analysis unit 22 serially analyzes operation items described in the operation-item definition file and recognizes the hierarchical structure of the operation items as illustrated in FIG. 6 as an example.

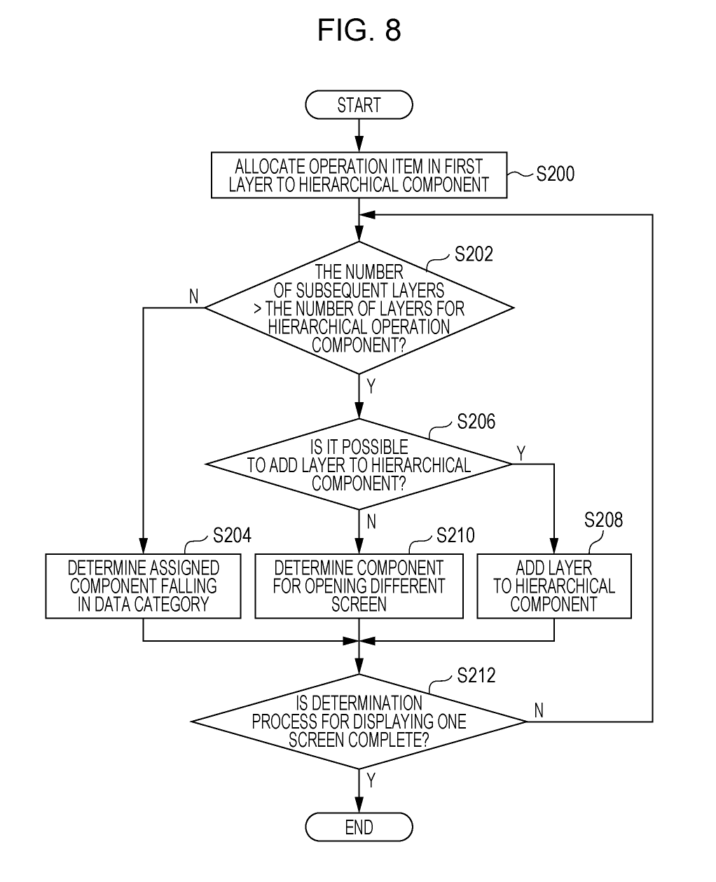

In step S106, the hierarchical-component/assigned-component determination unit 26 executes, on the basis of the result of the analysis of the operation-item definition file, the hierarchical-component/assigned-component determination process for determining assigned components to be allocated to the hierarchical components. The process then proceeds to step S108. Note that the hierarchical-component/assigned-component determination process is executed in steps in FIG. 8 (described later).

In step S108, the display-component generation unit 28 generates display data for displaying the operation screen on the basis of the result of the determination performed by the hierarchical-component/assigned-component determination unit 26. The series of steps is then terminated.

The hierarchical-component/assigned-component determination process above will be described with reference to FIG. 8. FIG. 8 is a flowchart specifically illustrating an example of the hierarchical-component/assigned-component determination process performed by the hierarchical-component/assigned-component determination unit 26.

In step S200, the hierarchical-component/assigned-component determination unit 26 allocates an operation item in the first layer to a hierarchical component in the first layer. The process then proceeds to step S202.

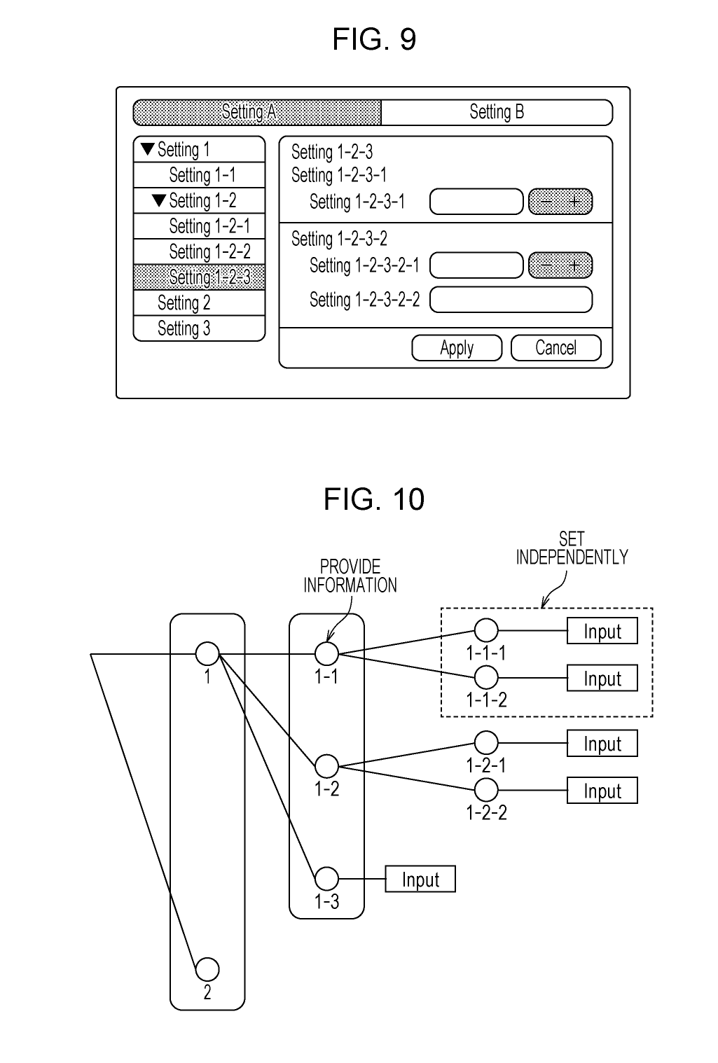

Specifically, in the example of the operation-item definition file illustrated in FIGS. 5A and 5B, as illustrated in FIG. 9, for example, operation items that are Setting A and Setting B are each allocated to the hierarchical component topNavigation in the design template illustrated in FIG. 3.

In step S202, the hierarchical-component/assigned-component determination unit 26 determines whether the number of subsequent layers for a subsequent operation item is larger than the number of layers for the hierarchical operation component on the basis of the operation-item definition file. In other words, the hierarchical-component/assigned-component determination unit 26 determines whether all of the operation items in the subsequent layers are displayable in the hierarchical operation component. If the result of the determination in step S202 is negative, the process proceeds to step S204. If the result of the determination is affirmative, the process proceeds to step S206. For example, in a case where Setting A in the operation-item definition file illustrated in FIG. 5A receives focus, the result of the determination in step S202 is affirmative because the number of subsequent layers is 4 and the number of layers for the hierarchical operation component illustrated in FIG. 3 is 2. In a case where the operation item that is Setting 1-2 in the operation-item definition file illustrated in FIG. 5A receives focus, the result of the determination in step S202 is negative because the number of subsequent layers is 2 and the number of layers for the hierarchical operation component illustrated in FIG. 3 is 2.

In step S204, the hierarchical-component/assigned-component determination unit 26 determines an assigned component falling in the data category, and the hierarchical-component/assigned-component determination process is terminated. In other words, in accordance with the operation-item definition file, the hierarchical-component/assigned-component determination unit 26 determines an assigned component for the operation item to be allocated to the hierarchical operation component.

In step S206, the hierarchical-component/assigned-component determination unit 26 determines whether it is possible to add a layer to the corresponding hierarchical component. Specifically, the hierarchical-component/assigned-component determination unit 26 determines whether it is possible to add a layer to the hierarchical component receiving focus at the time of the determination. For example, in the case of the hierarchical component leftNavigation in FIG. 3, the number of displayable layers is 3 as described above, and it is determined whether an assigned component for any of the three layers is undetermined. If the result of the determination in step S206 is affirmative, the process proceeds to step S208. If the result of the determination is negative, the process proceeds to step S210.

In step S208, the hierarchical-component/assigned-component determination unit 26 adds a layer to the hierarchical component. In other words, the hierarchical-component/assigned-component determination unit 26 adds a layer to the hierarchical component and allocates the operation item to the hierarchical component.

In step S210, the hierarchical-component/assigned-component determination unit 26 determines a component for opening a different screen.

After the end of step S204, step S210, or step S208, it is determined in step S212 whether the determination process for displaying one screen is complete. If the result of the determination is negative, an operation item in the next layer receives focus. The process returns to step S202, and the above described steps are repeated. If the result of the determination is affirmative, the process is terminated.

In the exemplary embodiment, only generating and inputting the operation-item definition file in the operation-screen generation device 10 causes the process described above to be executed to generate an operation screen having layers. For example, in a case where the operation-item definition file illustrated in FIGS. 5A and 5B is read and an operation screen is generated by using the design template illustrated in FIG. 2 and the definition of the assigned components illustrated in FIG. 4, an operation screen for the hierarchical display illustrated in FIG. 9 is generated. Note that the example in FIG. 9 illustrates a state where “Setting 1-2-3-1” and “Setting 1-2-3-2” in “Setting 1-2-3” in a layer lower than the layer for “Setting A” are operable.

A modification of the hierarchical-component/assigned-component determination process performed by the hierarchical-component/assigned-component determination unit 26 will be described.

For example, as illustrated in FIG. 10, Parameter 1-1-1 and Parameter 1-1-2 are intended to be set collectively but separately from the other parameters (operation items). In such a case, information indicating that the operation items are intended to be set collectively is provided in the operation-item definition file, and the operation items are settable independently from the other operation items.

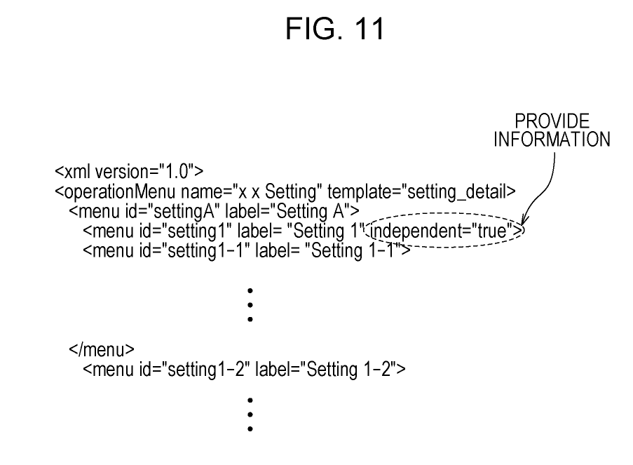

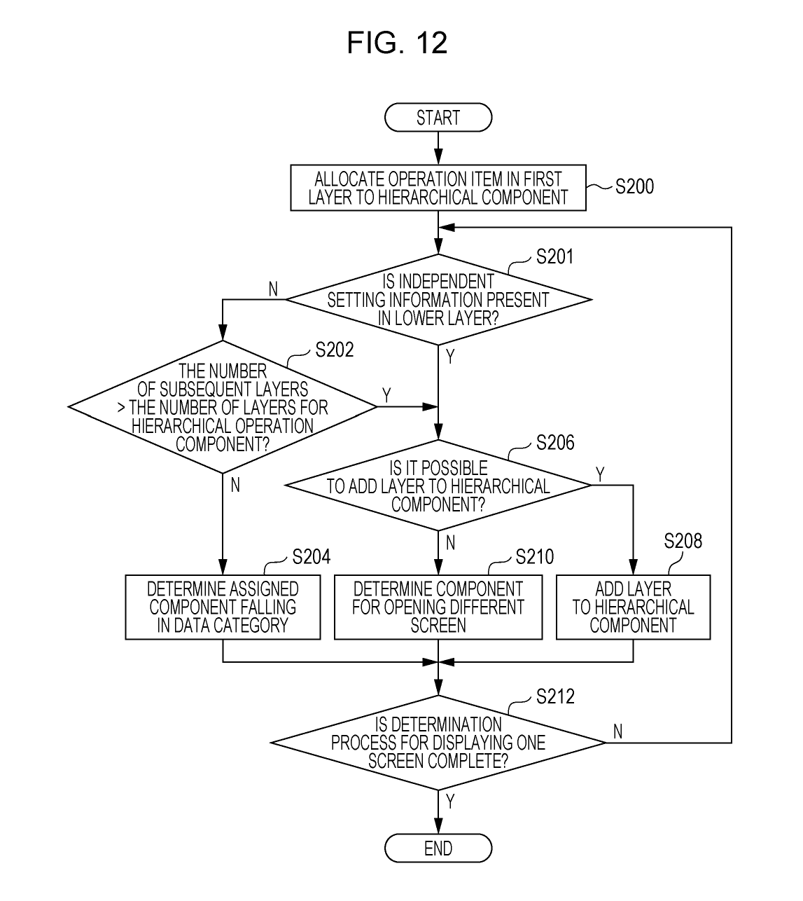

As illustrated in FIG. 11, an operation item is provided with, for example, information (independent=“true”) as the information provided in the operation-item definition file. In accordance with a process illustrated in FIG. 12, a hierarchical-component/assigned-component determination process is executed. FIG. 12 is a flowchart illustrating an example of the hierarchical-component/assigned-component determination process executed in a case where operation items are to be collectively set. Note that in the process in FIG. 12, step S201 is added to the process in FIG. 8, and the other steps are the same as those in the process in FIG. 8.

Specifically, after the hierarchical-component/assigned-component determination unit 26 allocates an operation item in the first layer to a hierarchical component in step S200, the process proceeds to step S201. The hierarchical-component/assigned-component determination unit 26 determines whether information indicating that an operation item is to be independently set (also referred to as independent setting information) is present in the lower layer. Specifically, the hierarchical-component/assigned-component determination unit 26 determines whether the operation-item definition file has the above-described information (for example, independent=“true”). If the result of the determination is negative, the process proceeds to step S202 described above. If the result of the determination is affirmative, the process proceeds to step S206 described above. If operation items are intended to be collectively set, an operation screen on which the operation items are displayable independently from the other operation items is thereby generated.

Note that in the exemplary embodiment, if it is not possible to add a layer to the hierarchical component (if the result of the determination in step S206 is negative), an operation screen from which a different screen is opened is generated. However, the configuration of the exemplary embodiment is not limited to this configuration. For example, the design template may be changed to another type of design template, and the generation of an operation screen may be started from scratch.

The processes in FIGS. 7, 8, and 12 that are executed by the operation-screen generation device 10 according to the exemplary embodiment described above may be executed by software, by hardware, or a combination of these. The processes executed by the operation-screen generation device 10 may be stored as a program in the storage medium and may be distributed.

The exemplary embodiment is not limited to the exemplary embodiment described above. It goes without saying that the exemplary embodiment may be performed after any of various modifications is made without departing from the spirit of the exemplary embodiment.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An operation-screen generation device comprising:
a reading unit that reads operation item information indicating a plurality of operation items having a hierarchical structure, the operation items being used to generate an operation screen; and
a generation unit that generates the operation screen such that an operation component for one of the operation items that is located in a highest layer in the hierarchical structure in the operation item information read by the reading unit is allocated to a first hierarchical component for hierarchically displaying the operation items by using a predetermined number of layers, the first hierarchical component being predetermined as being located in a highest layer in layout information indicating layout of the first hierarchical component and a second hierarchical component for displaying the operation items by using a predetermined number of layers and for operating the operation items, the generation unit generating the operation screen such that if the number of subsequent layers for one or more subsequent operation items in the hierarchical structure is equal to or smaller than the predetermined number of layers displayable for the second hierarchical component, one or more operation components for the one or more subsequent operation items are allocated to the second hierarchical component, the generation unit generating the operation screen such that if the number of subsequent layers is larger than the predetermined number of layers displayable for the second hierarchical component, the operation components for the subsequent operation items are allocated to the second hierarchical component and a third hierarchical component.

2. The operation-screen generation device according to claim 1,
wherein the number of layers displayable for the third hierarchical component is predetermined, and
wherein the generation unit generates the operation screen on a basis of whether using the third hierarchical component in addition to the second hierarchical component makes allocatable operation components for all of the subsequent operation items.

3. The operation-screen generation device according to claim 2,
wherein the generation unit generates the operation screen such that if the number of subsequent layers is larger than the predetermined number of layers displayable for the second hierarchical component and smaller than a total of the predetermined number of layers displayable for the second hierarchical component and the predetermined number of layers displayable for the third hierarchical component, an operation component for one of the operation items and not allocated to the second hierarchical component is allocated to the third hierarchical component.

4. The operation-screen generation device according to claim 1,
wherein the generation unit generates the operation screen such that if the number of subsequent layers is larger than the predetermined number of layers displayable for the second hierarchical component and larger than a total of the predetermined number of layers displayable for the second hierarchical component and the predetermined number of layers displayable for the third hierarchical component, a component for displaying a screen different from the operation screen is allocated.

5. The operation-screen generation device according to claim 2,
wherein the generation unit generates the operation screen such that if the number of subsequent layers is larger than the predetermined number of layers displayable for the second hierarchical component and larger than a total of the predetermined number of layers displayable for the second hierarchical component and the predetermined number of layers displayable for the third hierarchical component, a component for displaying a screen different from the operation screen is allocated.

6. The operation-screen generation device according to claim 3,
wherein the generation unit generates the operation screen such that if the number of subsequent layers is larger than the predetermined number of layers displayable for the second hierarchical component and larger than the total of the predetermined number of layers displayable for the second hierarchical component and the predetermined number of layers displayable for the third hierarchical component, a component for displaying a screen different from the operation screen is allocated.

7. The operation-screen generation device according to claim 1,
wherein in a case where the operation item information is provided in advance with information indicating that operation items are intended to be collectively set, the generation unit generates the operation screen such that operation components representing the operation items to be collectively set are allocated to the third hierarchical component.

8. The operation-screen generation device according to claim 2,
wherein in a case where the operation item information is provided in advance with information indicating that operation items are intended to be collectively set, the generation unit generates the operation screen such that operation components representing the operation items to be collectively set are allocated to the third hierarchical component.

9. The operation-screen generation device according to claim 3,
wherein in a case where the operation item information is provided in advance with information indicating that operation items are intended to be collectively set, the generation unit generates the operation screen such that operation components representing the operation items to be collectively set are allocated to the third hierarchical component.

10. The operation-screen generation device according to claim 7,
wherein in a case where the operation item information is provided in advance with the information indicating that operation items are intended to be collectively set and where operation components for all of the operation items are not allocatable even though the third hierarchical component is used, the generation unit generates the operation screen such that a component for displaying a different screen for the operation items intended to be collectively set is allocated.

11. The operation-screen generation device according to claim 8,
wherein in a case where the operation item information is provided in advance with the information indicating that operation items are intended to be collectively set and where operation components for all of the operation items are not allocatable even though the third hierarchical component is used, the generation unit generates the operation screen such that a component for displaying a different screen for the operation items intended to be collectively set is allocated.

12. The operation-screen generation device according to claim 9,
wherein in a case where the operation item information is provided in advance with the information indicating that operation items are intended to be collectively set and where operation components for all of the operation items are not allocatable even though the third hierarchical component is used, the generation unit generates the operation screen such that a component for displaying a different screen for the operation items intended to be collectively set is allocated.

13. A non-transitory computer readable medium storing an operation-screen generation program causing a computer to function as the generation unit of the operation-screen generation device according to claim 1.
